(19) United States
(12) Patent Application Publication
(10) Pub. No.: US 2013/0084871 A1
(43) Pub. Date: Apr. 4, 2013

(54) RADIO BASE STATION AND METHOD OF CONTROLLING THE SAME

(71) Applicants: Mitsuhiro Kitaji, Yokohama-shi (JP); Chiharu Yamazaki, Ota-ku (JP)

(72) Inventors: Mitsuhiro Kitaji, Yokohama-shi (JP); Chiharu Yamazaki, Ota-ku (JP)

(73) Assignee: KYOCERA CORPORATION, Kyoto (JP)

(21) Appl. No.: 13/702,570

(22) PCT Filed: Jun. 8, 2011
(86) PCT No.: PCT/JP2011/063109

§ 371 Date: Dec. 6, 2012

(30) Foreign Application Priority Data
Jun. 9, 2010 (JP) 2010-131892

(51) Int. Cl. H04W 36/00

(52) U.S. Cl. CPC H04W 36/0083
USPC 455/436

(57) ABSTRACT

A radio base station eNB#1 comprises: a storage unit 130 configured to store a handover parameter for controlling handover of radio terminals, in association with moving velocity information indicating a moving velocity of a given radio terminal; and a controller 120 configured to detect handover failure and control the storage unit 120 to adjust the handover parameter associated with the moving velocity information indicating a failure-detected moving velocity being a moving velocity of a radio terminal to which the handover failure is detected.

### TECHNICAL FIELD

The present invention relates to a radio base station and a method of controlling the same which employ SON technology.

### BACKGROUND ART

SON (Self Organizing Network) technology is employed in LTE (Long Term Evolution) which is standardized by the 3GPP (3rd Generation Partnership Project) as a standardization organization for radio communication system. SON technology enables a radio base station itself to adjust the parameter settings of the radio base station without human intervention.

In order to reduce a failure rate of handover of a radio terminal (i.e., change of the connection target base station), a method of optimizing a handover parameter for controlling the handover is proposed as one aspect of SON technology (see Non-patent Document 1, for example). In this method, the handover parameter is adjusted based on handover failure information on handover failure.

The handover parameter optimization makes it possible to suppress deterioration of communication quality and waste of network resources due to the handover failure. Such optimization technique is referred to as MRO (Mobility Robustness Optimization). See Non-patent Documents 1 and 2 as to examples of the handover parameter.

### PRIOR ART DOCUMENTS

### Non-Patent Documents

Non-patent Document 1: 3GPP TR36.902 “4.5 Mobility Robustness Optimization”

Non-patent Document2:3GPPTS36.331“5.5.4 Measurement report triggering”

### SUMMARY OF THE INVENTION

MRO mentioned above is based on the assumption that the same handover parameter is applied to all radio terminals which are targets for control of handover from one radio base station to another radio base station.

However, employing such a method incurs the following problem. Specifically, the radio transmission environment varies depending on the moving velocity of a radio terminal, and the optimum handover parameter varies from one radio transmission environment to another. Hence, the above method might not be able to adjust the handover parameter properly, and thus might not be able to reduce the handover failure rate sufficiently.

Thus, an objective of the present invention is to provide a radio base station and a method of controlling the same which are capable of reducing the handover failure rate sufficiently.

In order to solve the problem described above, the present invention has features below. First, a feature of a radio base station according to the present invention is summarized as follows. The radio base station comprises: a storage unit (storage unit 130) configured to store a handover parameter for controlling handover of radio terminals, in association with moving velocity information indicating a moving velocity of a given radio terminal; and a controller (controller 120) configured to detect handover failure and control the storage unit to adjust the handover parameter associated with the moving velocity information indicating a failure-detected moving velocity being a moving velocity of a radio terminal to which the handover failure is detected.

With the radio base station, the handover parameter can be appropriately adjusted by adjusting the handover parameter for each moving velocity, and thus the handover failure rate can be sufficiently reduced.

Another feature of a radio base station according to the present invention is summarized as follows. In the radio base station according to the aforementioned feature, the controller acquires the handover parameter associated with the moving velocity information indicating a moving velocity of a radio terminal being connected to the radio base station, from the storage unit, and controls handover of the radio terminal being connected with the radio base station, by using the acquired handover parameter.

Another feature of a radio base station according to the present invention is summarized as follows. In the radio base station according to the aforementioned feature, the controller controls the storage unit to adjust the handover parameter associated with the moving velocity information indicating the failure-detected moving velocity, based on a reason for the handover failure.

Another feature of a radio base station according to the present invention is summarized as follows. In the radio base station according to the aforementioned feature, when the reason for the failure is that the handover start is too late, the controller adjusts the handover parameter associated with the moving velocity information indicating the failure-detected moving velocity, such that the handover start is moved up earlier.

Another feature of a radio base station according to the present invention is summarized as follows. In the radio base station according to the aforementioned feature, when the reason for the failure is that the handover start is too early, the controller adjusts the handover parameter associated with the moving velocity information indicating the failure-detected moving velocity, such that the handover start is postponed.

Another feature of a radio base station according to the present invention is summarized as follows. In the radio base station according to the aforementioned feature, when the reason for the failure is wrong selection of a handover target radio base station, the controller adjusts the handover parameter associated with the moving velocity information indicating the failure-detected moving velocity, such that the handover target radio base station is selected properly.

A feature of a controlling method according to the present invention is summarized as follows. The method of controlling a radio base station comprises the steps of: associating a handover parameter for controlling handover of a radio terminal, with moving velocity information indicating a moving velocity of a given radio terminal; detecting handover failure; and adjusting the handover parameter associated with the moving velocity information indicating a failure-detected moving velocity being a moving velocity of a radio terminal to which the handover failure is detected.

### BRIEF DESCRIPTION OF THE DRAWINGS

FIG. 1 is a general system configuration diagram for describing the outline of a radio communication system according to an embodiment of the present invention.

FIG. 2A is a conceptual diagram for describing the type of handover failure (reason for failure) according to the embodiment of the present invention (part 1).

FIG. 2B is a conceptual diagram for describing the type of handover failure (reason for failure) according to the embodiment of the present invention (part 2).

FIG. 2C is a conceptual diagram for describing the type of handover failure (reason for failure) according to the embodiment of the present invention (part 3).

FIG. 3 is a block diagram showing the configuration of a radio base station according to the embodiment of the present invention.

FIG. 4A is a conceptual diagram for describing a configuration example of a parameter table according to the embodiment of the present invention (part 1).

FIG. 4B is a conceptual diagram for describing the configuration example of the parameter table according to the embodiment of the present invention (part 2).

FIG. 5 is an operational sequence diagram showing an operation pattern 1 of the radio communication system according to the embodiment of the present invention.

FIG. 6 is an operational sequence diagram showing an operation pattern 2 of the radio communication system according to the embodiment of the present invention.

### DETAILED DESCRIPTION OF THE EMBODIMENTS

Embodiments of the present invention will be described with reference to the drawings. Specifically, a description will be given of: (1) Outline of Radio Communication System; (2) Configuration of Radio Base Station; (3) Operation

Example of Radio Communication System; (4) Effect of Embodiment; and (5) Other Embodiments. In the following description of the drawings in the embodiments, the same or similar portions are assigned the same or similar reference numerals.

### (1) Outline of Radio Communication System

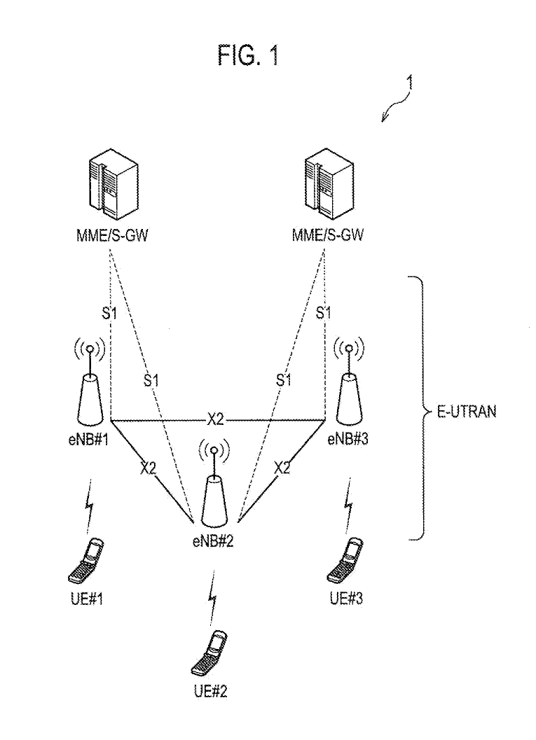

FIG. 1 is a general system configuration diagram for describing the outline of a radio communication system 1 according to this embodiment. The radio communication system 1 is compliant with LTE standards.

As shown in FIG. 1, multiple radio base stations eNB (radio base stations eNB#1 to eNB#3) constitute E-UTRAN (Evolved-UMTS Terrestrial Radio Access Network). Each of the multiple radio base stations eNB forms a cell being a communication area in which a service should be provided to radio terminals UE.

Every two neighboring radio base stations eNB can communicate with each other via an X2 interface which is a logical communication channel for providing communications between the base stations. Each of the multiple radio base stations eNB can communicate with the EPC (Evolved Packet Core), more specifically, with the MME (Mobility Management Entity)/S-GW (Serving Gateway) via an S1 interface.

A radio terminal UE is a radio communication device held by the user and is also called user equipment. A radio terminal UE#1 is connected to the radio base station eNB#1 in a cell formed by the radio base station eNB#1. A radio terminal UE#2 is connected to the radio base station eNB#2 in a cell formed by the radio base station eNB#2. A radio terminal UE#3 is connected to the radio base station eNB#3 in a cell formed by the radio base station eNB#3.

Each radio terminal UE measures the quality of a radio signal (i.e., radio quality) received from each radio base station eNB, and sends its connection target radio base station eNB a Measurement Report message being a report on the measurement result of the radio quality. Here, an example of the radio quality is the reference signal received power (RSRP). The Measurement Report message may be sent from the radio terminal UE to the radio base station eNB with a certain event set by the radio base station eNB used as a trigger, or instead may be sent from the radio terminal UE to the radio base station eNB regularly.

The connection target radio base station eNB of the radio terminal UE carries out handover control for changing the connection target of the radio terminal UE, on the basis of the Measurement Report message received from the radio terminal UE. In the case where the radio terminal UE receives reference signals from the respective radio base stations eNB, the Measurement Report message may include multiple RSRPs for the multiple radio base stations eNB. The connection target radio base station eNB of the radio terminal UE controls handover (hereinafter abbreviated as “HO” as needed) on the basis of the Measurement Report message in such a way that, for example, one of the multiple radio base stations eNB having the largest RSRP is set as a next connection target of the radio terminal UE.

The radio communication system 1 supports MRO described above. In this embodiment, each radio base station eNB adjusts a handover parameter upon detection of handover failure of the radio terminal UE. An example of such a handover parameter is an offset value for revising the RSRP measured by the radio terminal UE. For instance, in the case where the radio terminal UE#1 can receive radio signals from the radio base station eNB#1 and the radio base station eNB#2 respectively, before RSRP#1 for the radio base station eNB#1 and RSRP#2 for the radio base station eNB#2 are compared with each other, an offset value for revising the RSRP#1 to a larger value is added to the RSRP#1. Note that each pair of radio base stations eNB has one offset value and the offset value is shared by the paired radio base stations eNB.

Hereinbelow, a description will be given mainly of a case where a handover parameter of the radio base station eNB#1 is adjusted upon failure of a radio terminal UE, connected to the radio base station eNB#1, to be handed over to the radio base station eNB#2.

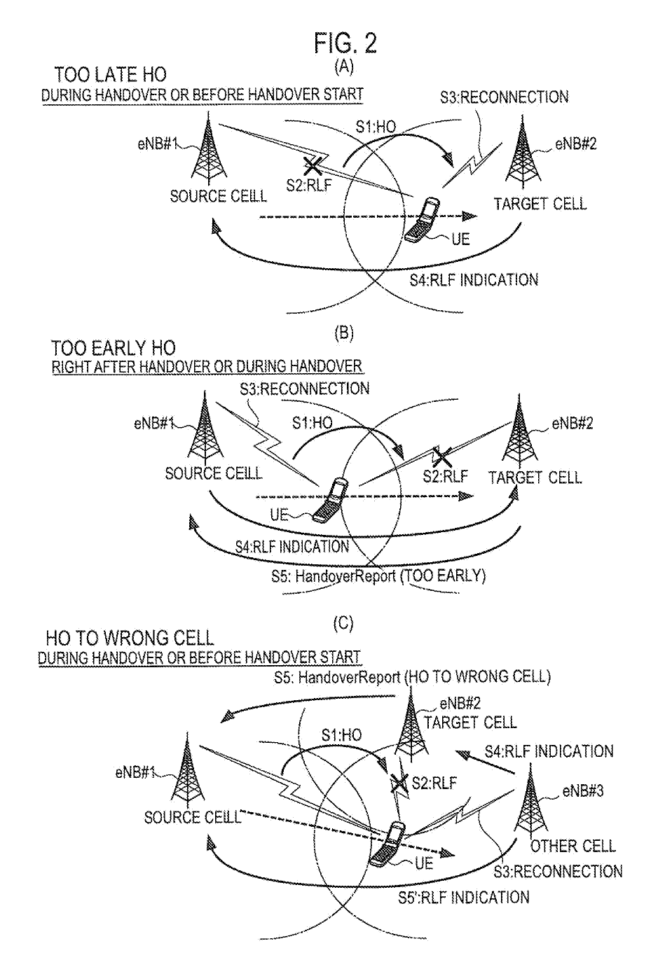

As shown in FIG. 2, in MRO, three types of handover failure are defined according to the reason for handover failure: “Too Late HO;” “Too Early HO;” and “HO to Wrong Cell” (see Non-patent Document 1).

As shown in FIG. 2A, Too Late HO denotes that radio link disconnection (RLF: Radio Link Failure) occurs between the handover source radio base station eNB#1 and the radio terminal UE (Step S2) before handover start or during handover (Step S1) because the handover start is too late. In this case, the radio terminal UE tries to reconnect to the handover target radio base station eNB#2 or a radio base station eNB other than the handover source radio base station eNB#1 (Step S3). The reconnection target radio base station eNB gives a RLF Indication message indicating the occurrence of Too Late HO to the handover source radio base station eNB#1 (Step S4).

As shown in FIG. 2B, Too Early HO denotes that RLF occurs between the handover target radio base station eNB#2 and the radio terminal UE (Step S2) right after handover or during handover (Step S1) because the handover start is too early. In this case, the radio terminal UE tries to reconnect to the handover source radio base station eNB#1 (Step S3). Upon receipt of a RLF Indication message from the handover source radio base station eNB#(Step S4), the handover target radio base station eNB#2 may send the handover source radio base station eNB#1 a Handover Report message indicating the occurrence of Too Early HO (Step S5) if the handover target radio base station eNB#2 has already sent the handover source radio base station eNB#1 a UE Context Release message relating to handover completion.

As shown in FIG. 2C, HO to Wrong Cell denotes that RLF occurs between the handover target radio base station eNB#2 and the radio terminal UE (Step S2) right after success of handover or during handover from the handover source radio base station eNB#1 to the handover target radio base station eNB#2 (Step S1) due to wrong selection of a handover target radio base station eNB. In this case, the radio terminal UE tries to reconnect to the handover source radio base station eNB#1 and the radio base station eNB#3 other than the handover target radio base station eNB#2 (Step S3). Upon receipt of a RLF Indication message from the radio base station eNB#3 other than the handover source radio base station eNB#1 (Step S4), the handover target radio base station eNB#2 may notify the handover source radio base station eNB#1 of the occurrence of HO to Wrong Cell by means of a Handover Report message (Step S5) if the handover target radio base station eNB#2 has already sent the handover source radio base station eNB#1 a UE Context Release message. In addition, if the handover from the handover source radio base station eNB#1 to the handover target radio base station eNB#2 fails and the radio terminal UE tries to reconnect to the different radio base station eNB#3, the radio base station eNB#3 may send the handover source radio base station eNB#1 a RLF Indication message (Step S5′).

### (2) Configuration of Radio Base Station

Next, the configuration of the radio base station eNB#1 will be described. The radio base stations eNB other than the radio base station eNB#1 have the same configuration as the radio base station eNB#1.

### (2.1) Configuration of Functional Blocks

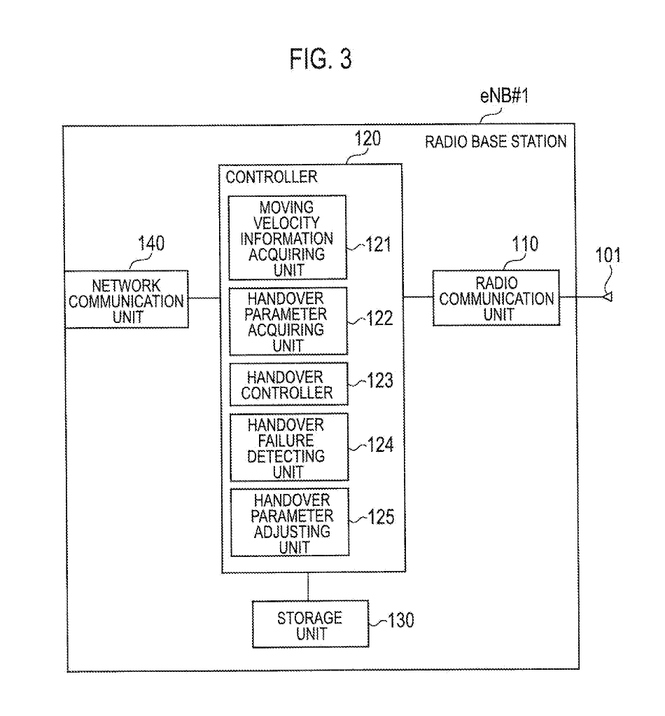

FIG. 3 is a block diagram showing the configuration of the radio base station eNB#1.

As shown in FIG. 3, the radio base station eNB#1 includes: an antenna unit 101; a radio communication unit 110; a controller 120; a storage unit 130; and a network communication unit 140.

The antenna unit 101 is used for sending and receiving radio signals. The radio communication unit 110 includes a radio frequency (RF) circuit, a baseband (BB) circuit, and the like, for example, and exchanges radio signals with each radio terminal UE. The radio communication unit 110 also modulates and codes a sending signal, and demodulates and decodes a reception signal.

The controller 120 includes a CPU, for example, and controls various functional blocks that the radio base station eNB#1 has. The storage unit 130 includes a memory, for example, and stores various kinds of information used for, for example, control performed by the radio base station eNB#1. The network communication unit 140 performs inter-base station communications using an X2 interface and communications using an S1 interface.

The storage unit 130 stores a parameter table associating a handover parameter for controlling handover of radio terminals UE with moving velocity information indicating the moving velocity of a given radio terminal. The handover parameter denotes an offset value to be added to RSRP measured by each radio terminal UE, or a threshold to be compared with the RSRP measured by the radio terminal UE. A specific example of the parameter table will be described later.

The controller 120 includes: a moving velocity information acquiring unit 121; a handover parameter acquiring unit 122; a handover controller 123; a handover failure detecting unit 124; and a handover parameter adjusting unit 125.

The moving velocity information acquiring unit 121 acquires moving velocity information indicating the moving velocity of a radio terminal UE connected to the radio base station eNB#1. More specifically, in the case where the radio terminal UE has a GPS (Global Positioning System) positioning function, the moving velocity information acquiring unit 121 acquires moving velocity information by means of locations measured by GPS and time intervals at which these locations are measured. In the case where the radio terminal UE has no GPS positioning function, the moving velocity information acquiring unit 121 acquires moving velocity information by means of locations of the radio terminal UE, which are measured by a terminal location measuring server (E-SLMC: Evolved Serving Mobile Location Center) provided on a core network side, and time intervals at which these locations are measured. Alternatively, the moving velocity information acquiring unit 121 may acquire moving velocity information by means of a fading pitch of a radio signal that the radio communication unit 110 receives from the radio terminal UE, or instead may acquire moving velocity information by means of information on the number of cells that the radio terminal UE passes through per unit time. Still alternatively, the moving velocity information acquiring unit 121 may acquire moving velocity information by means of a period during which the radio terminal UE stays in a cell of the radio base station eNB#1 and information on handover history of the radio terminal UE. See 3GPP TS36.305 for details of the terminal location measuring server (E-SLMC). Further, the moving velocity information acquiring unit 121 may acquire moving velocity information of the radio terminal UE by using not only the above moving velocity information acquiring methods but also another existing moving velocity acquiring method.

The handover parameter acquiring unit 122 acquires a handover parameter associated with the moving velocity information acquired by the moving velocity information acquiring unit 121, from the parameter table stored in the storage unit 130.

The handover controller 123 makes a conditional judgment on whether or not to make a radio terminal UE perform handover, on the basis of a Measurement Report message that the radio communication unit 110 receives from the radio terminal UE and the handover parameter acquired by the handover parameter acquiring unit 122.

For instance, assume a case where the Measurement Report message includes RSRP#1 for the radio base station eNB#1 and RSRP#2 for the radio base station eNB#2 and the handover parameter is an offset value of x [dB] to be added to the RSRP#2. In this case, the handover controller 123 compares the RSRP#1 with (RSRP#2+x). Then, if (RSRP#2+x) is larger than the RSRP#1, the handover controller 123 performs handover control such that the radio terminal UE performs handover to the radio base station eNB#2. On the other hand, if (RSRP#2+x) is smaller than the RSRP#1, the handover controller 123 performs control such that the radio terminal UE does not perform handover to the radio base station eNB#2.

The handover failure detecting unit 124 detects handover failure of a radio terminal UE after it is determined that the handover controller 123 makes the radio terminal perform handover to the handover target radio base station eNB#2.

Specifically, the handover failure detecting unit 124 detects Too Late HO from a RLF Indication message that the network communication unit 140 receives from the handover target radio base station eNB#2, the RLF Indication message indicating the occurrence of Too Late HO.

In addition, the handover failure detecting unit 124 detects Too Early HO from the reconnection of the radio terminal UE to the radio base station eNB#1. Alternatively, the handover failure detecting unit 124 detects Too Early HO from a Handover Report message that the network communication unit 140 receives from the handover target radio base station eNB#2, the Handover Report message indicating the occurrence of Too Early HO.

Moreover, the handover failure detecting unit 124 detects HO to Wrong Cell from a Handover Report message that the network communication unit 140 receives from the handover target radio base station eNB#2, the Handover Report message indicating the occurrence of HO to Wrong Cell. Alternatively, the handover failure detecting unit 124 detects HO to Wrong Cell from a RLF Indication message that the network communication unit 140 receives from the different radio base station eNB#3, the RLF Indication message indicating the occurrence of HO to Wrong Cell.

The handover failure detecting unit 124 stores the status of handover failure detected by the handover failure detecting unit 124 in the storage unit 130 in association with the moving velocity information acquired by the moving velocity information acquiring unit 121. Hereinafter, the moving velocity of a radio terminal UE the handover failure of which is detected is referred to as a failure-detected moving velocity. The handover failure detecting unit 124 stores the moving velocity information indicating the failure-detected moving velocity in the storage unit 130 in association with the type of the handover failure (Too Late HO, Too Early HO, or HO to Wrong Cell).

The handover parameter adjusting unit 125 refers to and controls the storage unit 130 in such a way as to adjust the handover parameter associated with the moving velocity information indicating the failure-detected moving velocity.

In response to Too Late HO, the handover parameter adjusting unit 125 adjusts the handover parameter associated with the moving velocity information indicating the failure-detected moving velocity at which Too Late HO has occurred, such that the handover start can be moved up earlier. In the example of FIG. 2A, the start of handover from the radio base station eNB#1 to the radio base station eNB#2 can be moved up by: adding a smaller offset value to the RSRP#1 for the radio base station eNB#1; or adding a larger offset value to the RSRP#2 for the radio base station eNB#2.

In response to Too Early HO, the handover parameter adjusting unit 125 adjusts the handover parameter associated with the moving velocity information indicating the failure-detected moving velocity at which Too Early HO has occurred, such that the handover start can be postponed. In the example of FIG. 2B, the start of handover from the radio base station eNB#1 to the radio base station eNB#2 can be postponed by: adding a larger offset value to the RSRP#1 for the radio base station eNB#1; or adding a smaller offset value to the RSRP#2 for the radio base station eNB#2.

In response to HO to Wrong Cell, the handover parameter adjusting unit 125 adjusts the handover parameter associated with the moving velocity information indicating the failure-detected moving velocity at which HO to Wrong Cell has occurred, such that the handover target radio base station eNB can be selected properly. In the example of FIG. 2C, the radio base station eNB#3 can be more likely to be selected as the handover target than the radio base station eNB#2 by: adding a smaller offset value to the RSRP#2 for the radio base station eNB#2; or adding a larger offset value to RSRP#3 for the radio base station eNB#3.

It is to be noted here that in order to adjust the handover parameter, it is necessary to get permission from the other radio base stations eNB. Hence, an adjusted handover parameter is notified by means of a Mobility Change Request message and, if it can be confirmed that the adjusted handover parameter is permitted, the handover parameter adjusting unit 125 adjusts the handover parameter. See 3GPP TS36.423 for details of messages for parameter adjustment exchanged between radio base stations eNB.

### (2.2) Configuration Example of Parameter Table

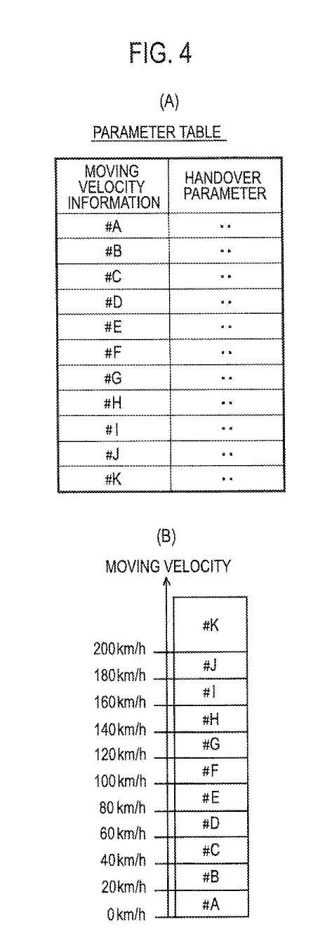

FIG. 4 is a conceptual diagram for describing a configuration example of the parameter table.

As shown in FIG. 4A, the parameter table is a table for associating the moving velocity information with the handover parameter. In the example of FIG. 4A, the handover parameter is associated with each of the pieces of moving velocity information #A to #K.

Initial handover parameter values for the respective pieces of moving velocity information #A to #K may be the same. The handover parameter for each moving velocity is optimized by making the handover parameter adjusting unit 125 adjust the handover parameter for each of the pieces of moving velocity information #A to #K.

As shown in FIG. 4B, the pieces of moving velocity information #A to #K indicate moving velocity segments of a given radio terminal UE. In the example of FIG. 4B, the moving velocity segments are set for every 20 km/h.

Assume a case where a radio terminal UE being connected to the radio base station eNB#1 moves to the radio base station eNB#2 at a moving velocity of 30 km/h. In this case, the handover parameter associated with the moving velocity information #B is applied to the radio terminal UE.

Note that the moving velocity segments shown in FIG. 4B are merely an example; the moving velocity may be segmented into a larger number of segments, or instead may be segmented into a smaller number of segments.

### (3) Operation Example of Radio Communication System

Next, the operation of the radio communication system 1 will be described while taking operation patterns 1 and 2 as an example. The operation pattern 1 indicates an operation when Too Late HO occurs, and the operation pattern 2 indicates an operation when Too Early HO occurs. Note that the outline of a handover sequence will be described in the following description of the operations; see 3GPP TS36.300 for details of the handover sequence.

### (3.1) Operation Pattern 1

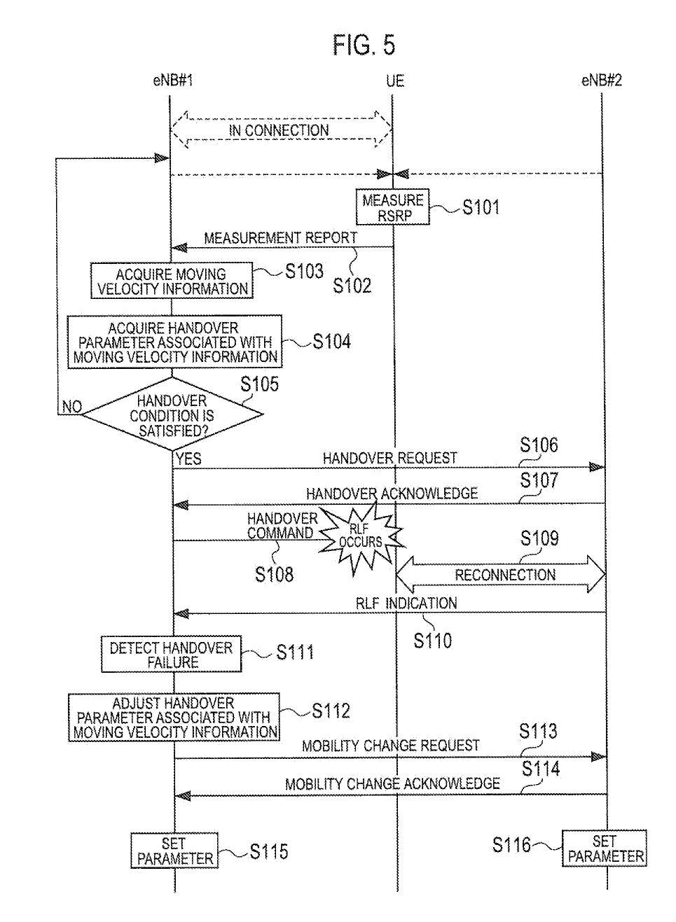

FIG. 5 is an operational sequence diagram showing the operation pattern 1 of the radio communication system 1. In this operation example, a radio terminal UE sends the radio base station eNB#1 a Measurement Report message periodically.

In Step S101, the radio terminal UE connected to the radio base station eNB#1 receives a reference signal from the radio base station eNB#1 and measures RSRP#1 by means of the received reference signal. Further, the radio terminal UE receives a reference signal from the radio base station eNB#2 and measures RSRP#2 by means of the received reference signal.

In Step S102, the radio terminal UE sends the radio base station eNB#1 a Measurement Report message including the measured RSRP#1 and RSRP#2. The radio communication unit 110 of the radio base station eNB#1 receives the Measurement Report message.

In Step S103, the moving velocity information acquiring unit 121 of the radio base station eNB#1 acquires moving velocity information of the radio terminal UE.

In Step S104, the handover parameter acquiring unit 122 of the radio base station eNB#1 refers to the parameter table stored in the storage unit 130, and acquires a handover parameter associated with the moving velocity information acquired by the moving velocity information acquiring unit 121.

In Step S105, the handover controller 123 of the radio base station eNB#1 makes a conditional judgment on whether or not to make the radio terminal UE perform handover, on the basis of the Measurement Report message that the radio communication unit 110 receives from the radio terminal UE and the handover parameter acquired by the handover parameter acquiring unit 122. The process moves to Step S106 if it is determined to make the radio terminal UE perform handover to the radio base station eNB#2, whereas the process returns to Step S101 if it is determined not to make the radio terminal UE perform handover to the radio base station eNB#2. Note that the handover parameter associated with the moving velocity information and acquired by the handover parameter acquiring unit 122 may be an offset to be added to a handover parameter subjected to usual adjustment; in this case, the handover controller 123 adds the handover parameter associated with the moving velocity information and acquired by the handover parameter acquiring unit 122 to the handover parameter subjected to usual adjustment, and uses the result of the addition to make a conditional judgment on whether or not to make the radio terminal UE perform handover.

In Step S106, the network communication unit 140 of the radio base station eNB#1 sends the radio base station eNB#2 a Handover Request message indicating request for acceptance of the radio terminal UE. The radio base station eNB#2 receives the Handover Request message.

In Step S107, the radio base station eNB#2 sends the radio base station eNB#1 a Handover Acknowledge message indicating that acceptance of the radio terminal UE is permitted. The network communication unit 140 of the radio base station eNB#1 receives the Handover Acknowledge message.

In Step S108, the radio communication unit 110 of the radio base station eNB#1 sends the radio terminal UE a Handover Command message indicating instructions for handover to the radio base station eNB#2. Assume that RLF occurs between the radio base station eNB#1 and the radio terminal UE at this point.

In Step S109, upon the occurrence of RLF between the radio terminal UE and the radio base station eNB#1, the radio terminal UE performs processing for reconnection to the radio base station eNB#2.

In Step S110, upon the reconnection of the radio terminal UE to the radio base station eNB#2, the radio base station eNB#2 sends the radio base station eNB#1 a RLF Indication message indicating the occurrence of Too Late HO. The network communication unit 140 of the radio base station eNB#1 receives the RLF Indication message indicating the occurrence of Too Late HO.

In Step S111, the handover failure detecting unit 124 of the radio base station eNB#1 detects Too Late HO from the RLF Indication message received by the network communication unit 140, the RLF Indication message indicating the occurrence of Too Late HO.

In Step S112, the handover parameter adjusting unit 125 refers to the storage unit 130 and adjusts a handover parameter associated with the moving velocity information indicating the failure-detected moving velocity, and thereby determines an adjusted handover parameter. Specifically, the handover parameter adjusting unit 125 adjusts the handover parameter associated with the moving velocity information indicating the failure-detected moving velocity, such that the handover start can be moved up earlier. Here, the moving velocity information acquired by the moving velocity information acquiring unit 121 in Step S103 is used as the moving velocity information indicating the failure-detected moving velocity.

In Step S113, the network communication unit 140 of the radio base station eNB#1 sends the radio base station eNB#2 a Mobility Change Request message including the adjusted handover parameter determined by the handover parameter adjusting unit 125. The radio base station eNB#2 receives the Mobility Change Request message.

In Step S114, the radio base station eNB#2 sends the radio base station eNB#1 a Mobility Change Acknowledge message if giving permission to the Mobility Change Request message. The network communication unit 140 of the radio base station eNB#1 receives the Mobility Change Acknowledge message.

In Step S115, the handover parameter adjusting unit 125 of the radio base station eNB#1 updates the handover parameter associated with the moving velocity information indicating the failure-detected moving velocity, with the adjusted handover parameter.

In Step S116, the radio base station eNB#2 sets the adjusted handover parameter in the radio base station itself.

### (3.2) Operation Pattern 2

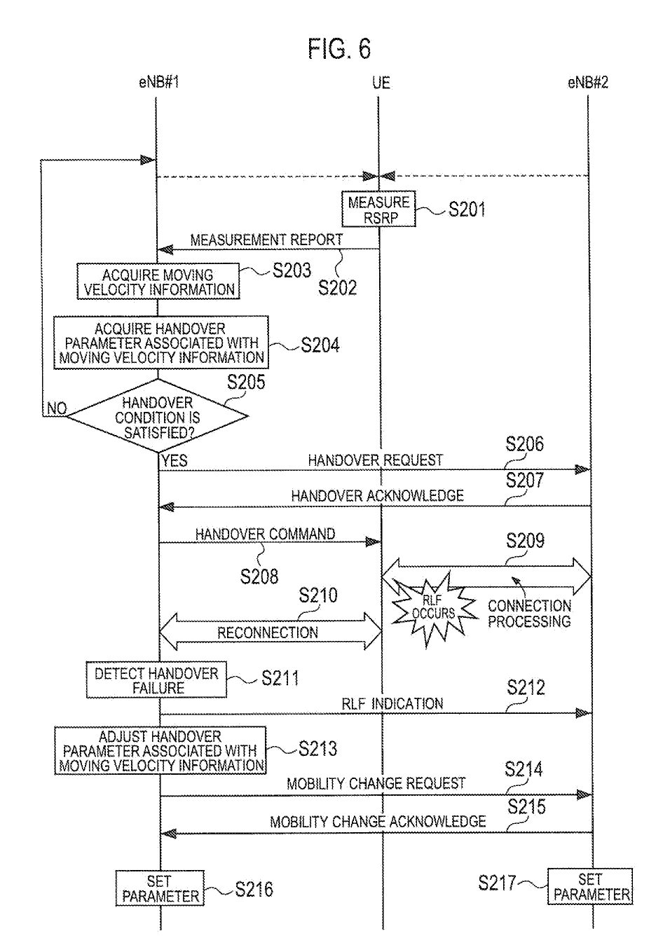

FIG. 6 is an operational sequence diagram showing the operation pattern 2 of the radio communication system 1. In this operation example, a radio terminal UE sends the radio base station eNB#1 a Measurement Report message periodically.

Processes in Steps S201 to S207 are carried out in the same way as the processes in Steps S201 to S207 described above.

In Step S208, the radio communication unit 110 of the radio base station eNB#1 sends the radio terminal UE a Handover Command message indicating instructions for handover to the radio base station eNB#2.

In Step S209, the radio terminal UE performs processing for connection to the radio base station eNB#2. Assume that RLF occurs between the radio base station eNB#2 and the radio terminal UE after this connection processing.

In Step S210, upon the occurrence of RLF between the radio terminal UE and the radio base station eNB#2, the radio terminal UE performs processing for reconnection to the radio base station eNB#1.

In Step S211, the handover failure detecting unit 124 of the radio base station eNB#1 detects Too Early HO from the reconnection performed by the radio terminal UE.

In Step S212, the network communication unit 140 of the radio base station eNB#1 sends the radio base station eNB#2 a RLF Indication message indicating the occurrence of Too Early HO. The radio base station eNB#2 receives the RLF Indication message.

In Step S213, the handover parameter adjusting unit 125 refers to the storage unit 130 and adjusts a handover parameter associated with the moving velocity information indicating a failure-detected moving velocity, and thereby determines an adjusted handover parameter. Specifically, the handover parameter adjusting unit 125 adjusts the handover parameter associated with the moving velocity information indicating the failure-detected moving velocity, such that the handover start can be postponed. Here, the moving velocity information acquired by the moving velocity information acquiring unit 121 in Step S203 is used as the moving velocity information indicating the failure-detected moving velocity.

In Step S214, the network communication unit 140 of the radio base station eNB#1 sends the radio base station eNB#2 a Mobility Change Request message including the adjusted handover parameter determined by the handover parameter adjusting unit 125. The radio base station eNB#2 receives the Mobility Change Request message.

In Step S215, the radio base station eNB#2 sends the radio base station eNB#1 a Mobility Change Acknowledge message if giving permission to the Mobility Change Request message. The network communication unit 140 of the radio base station eNB#1 receives the Mobility Change Acknowledge message.

In Step S216, the handover parameter adjusting unit 125 of the radio base station eNB#1 updates the handover parameter associated with the moving velocity information indicating the failure-detected moving velocity, with the adjusted handover parameter.

In Step S217, the radio base station eNB#2 sets the adjusted handover parameter in the radio base station itself.

### (4) Effect of Embodiment

As described above, the radio base station eNB#1 includes: the storage unit 130 storing a handover parameter in association with moving velocity information; and the controller 120 controlling the storage unit 130 in such a way as to adjust a handover parameter associated with moving velocity information indicating a failure-detected moving velocity. Thereby, the handover parameter can be optimized for each moving velocity, and thus the handover failure rate can be sufficiently reduced.

In this embodiment, the controller 120 of the radio base station eNB#1 acquires a handover parameter associated with moving velocity information indicating the moving velocity of a radio terminal UE being connected to the radio base station itself, from the storage unit 130. The controller 120 then makes a conditional judgment by using the acquired handover parameter. Thereby, the conditional judgment on handover can be performed by using the handover parameter which reflects the status of the past handover failure at the current moving velocity of the radio terminal UE, and thus the handover failure rate can be sufficiently reduced.

In this embodiment, in response to detection of Too Late HO, the controller 120 of the radio base station eNB#1 adjusts a handover parameter associated with moving velocity information indicating a moving velocity at which Too Late HO has occurred, such that the handover start can be moved up earlier. Thereby, it is possible to prevent another Too Late HO from occurring at the moving velocity at which Too Late HO has occurred.

In this embodiment, in response to detection of Too Early HO, the controller 120 of the radio base station eNB#1 adjusts a handover parameter associated with moving velocity information indicating a moving velocity at which Too Early HO has occurred, such that the handover start can be postponed. Thereby it is possible to prevent another Too Early HO from occurring at the moving velocity at which Too Early HO has occurred.

In this embodiment, in response to detection of HO to Wrong Cell, the controller 120 of the radio base station eNB#1 adjusts a handover parameter associated with moving velocity information indicating a moving velocity at which HO to Wrong Cell has occurred, in such a way that the handover target radio base station eNB is selected properly. Thereby, it is possible to prevent another HO to Wrong Cell from occurring at the moving velocity at which HO to Wrong Cell has occurred.

### (5) Other Embodiments

Although contents of the present invention have been described according to the foregoing embodiments of the invention, it should not be understood that descriptions and drawings constituting part of this disclosure limit the present invention. From this disclosure, various alternative embodiments, examples, and operation techniques will be easily found by those skilled in the art.

Although the offset value has been mainly described as the handover parameter in the above embodiment, a threshold to be compared with the RSRP may be adjusted for each moving velocity instead of the offset value. Moreover, although the conditional judgment using the handover parameter is carried out by the radio base station eNB#1, a part of the conditional judgment using the handover parameter may be carried out by the radio terminal UE.

Further, although in the above embodiment the description has been mainly given of the handover parameter related to the change of the connection target base station during communications, the present invention is also applicable to a cell reselection parameter which is a parameter related to the change of the connection target base station in an idle mode (during standby) (so-called cell reselection). In other words, in this specification, the handover parameter is an idea including the cell reselection parameter.

In the above embodiment, the radio communication system based on LTE (3GPP Release 8 or 9) has been described. However, a heterogeneous network, in which multiple types of radio base stations of varying transmission power coexist, is expected to be provided in LTE Advanced (3GPP Release 10) which is an advanced version of LTE, and the present invention may be applied to this heterogeneous network. Moreover, a relay node, which is a radio base station having a radio backhaul configuration, is expected to be provided in LTE Advanced, and this relay node may be employed as the radio base station according to the present invention.

Furthermore, although the LTE system has been described in the above embodiment, the present invention may be applied to another radio communication system such as a radio communication system based on Mobile WiMAX (IEEE 802.16e).

As described above, it should be understood that the present invention includes various embodiments and the like which are not described herein.

Note that the entire contents of Japanese Patent Application No. 2010-131892 (filed on Jun. 9, 2010) are incorporated herein by reference.

### INDUSTRIAL APPLICABILITY

As has been described, the radio base station and the method of controlling the same according to the present invention are capable of reducing the handover failure rate sufficiently, and thus are useful in radio communications such as mobile communications.

1. A radio base station comprising:
a storage unit configured to store a handover parameter for controlling handover of radio terminals, in association with moving velocity information indicating a moving velocity of a given radio terminal; and
a controller configured to detect handover failure and control the storage unit to adjust the handover parameter associated with the moving velocity information indicating a failure-detected moving velocity being a moving velocity of a radio terminal to which the handover failure is detected.

2. The radio base station according to claim 1, wherein the controller
acquires the handover parameter associated with the moving velocity information indicating a moving velocity of a radio terminal being connected to the radio base station, from the storage unit, and
controls handover of the radio terminal being connected with the radio base station, by using the acquired handover parameter.

3. The radio base station according to claim 1, wherein the controller controls the storage unit to adjust the handover parameter associated with the moving velocity information indicating the failure-detected moving velocity, based on a reason for the handover failure.

4. The radio base station according to claim 3, wherein, when the reason for the failure is that the handover start is too late, the controller adjusts the handover parameter associated with the moving velocity information indicating the failure-detected moving velocity, such that the handover start is moved up earlier.

5. The radio base station according to claim 3, wherein, when the reason for the failure is that the handover start is too early, the controller adjusts the handover parameter associated with the moving velocity information indicating the failure-detected moving velocity, such that the handover start is postponed.

6. The radio base station according to claim 3, wherein, when the reason for the failure is wrong selection of a handover target radio base station, the controller adjusts the handover parameter associated with the moving velocity information indicating the failure-detected moving velocity, such that the handover target radio base station is selected properly.

7. A method of controlling a radio base station comprising the steps of:
associating a handover parameter for controlling handover of a radio terminal, with moving velocity information indicating a moving velocity of a given radio terminal;
detecting handover failure; and
adjusting the handover parameter associated with the moving velocity information indicating a failure-detected moving velocity being a moving velocity of a radio terminal to which the handover failure is detected.
